(19) United States
(12) Patent Application Publication
(10) Pub. No.: US 2010/0257043 A1
(43) Pub. Date: Oct. 7, 2010

(54) METHOD AND SYSTEM TO EMBED APPLICATIONS IN A WEB PLATFORM

(76) Inventors: Farhang Kassaei, San Jose, CA (US); Raj Rao, Fremont, CA (US); Sivakumar Thiruppathy, Fremont, CA (US); Dalun Bao, San Jose, CA (US)

Correspondence Address: SCHWEGMAN, LUNDBERG & WOESSNER/EBAY, P.O. BOX 2938, MINNEAPOLIS, MN, 55402, US

(21) Appl. No.: 12/574,690

(22) Filed: Oct. 6, 2009

Related U.S. Application Data
(60) Provisional application No. 61/103,130, filed on Oct. 6, 2008.

(51) Int. Cl. G06Q 30/00; G06Q 10/00

(52) U.S. Cl. 705/14.23; 705/34; 705/27

(57) ABSTRACT

A method and system for embedding applications in a web platform are described. In order to subscribe to an embedded application, the web platform receives a subscription request from a user to subscribe to the application along with configuration data. The configuration data includes both default fields from the platform itself and application-specific data requested by the application developer. This data is provided to the developer who may authorize the subscription request, reject the subscription request, or inform the web platform that the subscription is pending and awaiting review for a decision at a later time.

### RELATED APPLICATIONS

This application claims the priority benefit of U.S. Provisional Application No. 61/103,130, filed Oct. 6, 2008, which is incorporated herein by reference.

### TECHNICAL FIELD

This application relates to the field of Internet-based commerce.

### BACKGROUND

With the widespread acceptance of the Internet as a ubiquitous, interactive communication and interaction platform, online commerce conducted over the Internet has become commonplace in a variety of business environments, including auctions and fixed price item sales. A number of online marketplaces are utilized by merchants as an important, if not a primary, distribution channel for products. These “power sellers” typically list a large number of items to be sold or auctioned each day.

In order to manage a high volume of sales, power sellers rely on marketplace and payment applications. Some of these applications are provided by the marketplace itself, whereas others are written and sold by third-party software developers. In order to discover these applications, especially third party ones, sellers typically have to search the Internet for them. Also, application writers must advertise their programs to make them easier to locate. As a result, sellers may not be aware of applications that could improve their ability to sell items, and they may not know which available applications will best meet their needs.

Furthermore, subscriptions to these third-party applications are handled outside of the web platform marketplace, and some sellers may not trust the third parties with payment details.

### BRIEF DESCRIPTION OF DRAWINGS

Embodiments of the present invention are illustrated by way of example and not limitation in the figures of the accompanying drawings, in which like reference numbers indicate similar elements.

FIG. 1 is a block diagram of a system within which a method and system to embed applications in a web platform may be implemented, according to an example embodiment.

FIG. 2 is a block diagram illustrating relationships between a third-party platform and an e-commerce platform, according to an example embodiment.

FIG. 3 is a block diagram illustrating modules of an application serving platform used in creating subscriptions, according to an example embodiment.

FIG. 4 is a workflow diagram illustrating a basic interaction between the application serving platform and the third-party application, according to an example embodiment.

FIG. 5 is a block diagram illustrating a lifecycle of a third-party application in the application serving platform, according to an example embodiment.

FIG. 6 is a workflow diagram illustrating an interaction between a user and the third-party application, according to an example embodiment.

FIG. 7 is a flow chart of a method of creating a subscription to a third-party application according to various example embodiments.

FIG. 8 is a block diagram illustrating a lifecycle of a subscription request to the application serving platform, according to an example embodiment.

FIG. 9 is a diagrammatic representation of a machine in the example form of a computer system within which set instructions for causing the machine to perform any one or more of the methodologies discussed herein may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details. Further, well-known instruction instances, protocols, structures, and techniques have not been shown in detail.

The application serving platform is a framework that enables third-party applications to offer custom functionality within the e-commerce marketplace. Rather than taking users off-site to access these tools, the application serving platform enables third-party developers to contribute to the e-commerce marketplace in a controlled and consistent manner. This effort enables the marketplace to leverage the strengths of the developer community to enhance the buying and selling experience on the marketplace.

As sellers scale, they may be able to add applications to their existing tool set without the need to migrate to a completely different environment, which enables them to grow on demand. For third-party developers, the application serving platform facilitates distribution of their applications to the sellers.

Further details regarding the various example embodiments described above will now be discussed with reference to the figures accompanying the present specification.

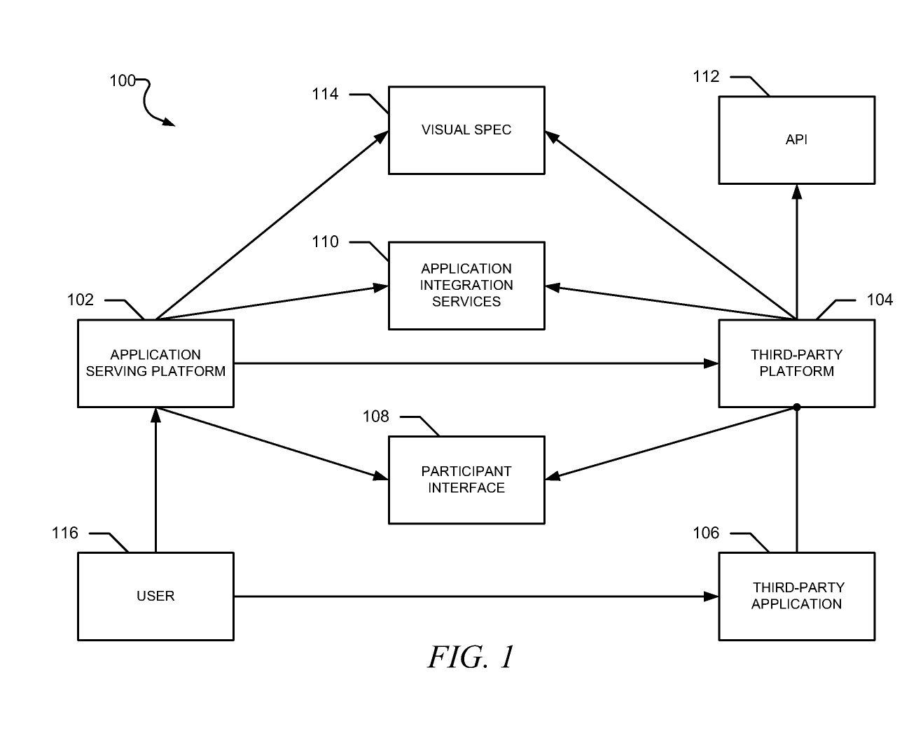

FIG. 1 is a block diagram 100 of a system within which a method and system to embed applications in a web platform may be implemented, according to an example embodiment. FIG. 1 shows the basic relationships between the parts of the system.

The application serving platform (ASP) 102 integrates with third-party platform 104, and deploys third-party applications 106 on the ASP 102.

The third-party platform 104 implements the Participant Interface (EPI) 108, invokes the Application Integration Service (EAIS) 110, and calls the API 112.

The third-party platform 104 and third-party applications 106 conform to the Visual Spec 114.

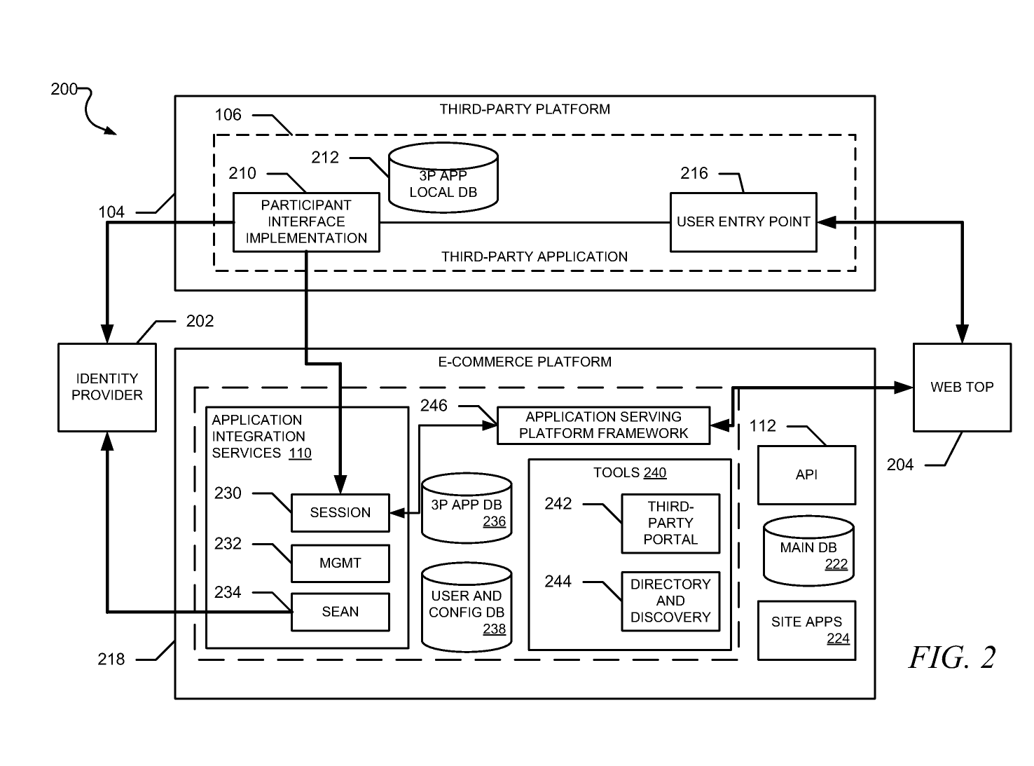

The User subscribes to third-party applications 106, and runs them in the Web Top 204 (shown in FIG. 2).

FIG. 2 is a block diagram 200 illustrating relationships between a third-party platform 104 and an e-commerce platform, according to an example embodiment.

The Web Top 204 is the end-user facing part of the ASP 102. It conforms to the ASP 102 standard visual specification that explains what the Web Top 204 may look like. The Web Top 204 includes the third-party canvas area, and a user entry point 216 to the Directory and Discovery application 244, which contains a list of user's installed and running apps. The third-party platform 104 also includes a local database 212 for user settings.

The ASP framework 246 is responsible for handling communication between third-party applications 106 and the Web Top 204. The ASP framework 246 manages sessions, generates requests to participating third parties, and handles responses.

Application Integration Services is a set of web based APIs implemented by the ASP 102 that third-party applications 106 invoke to integrate with the e-commerce platform 218. It includes a session 230 that is connected to the participant interface implementation 210 in the third-party application 106, a management module 232, and a simple event, alert, and notifications API (SEAN) 234 to publish alerts and notifications to users of third-party applications 106.

The Participant Interface 108 is a set of standard web based APIs that the ASP framework 246 invokes. Each third-party application 106 must contain a participant interface implementation 210 in order to integrate properly with the e-commerce platform 218.

The identity provider 202 is the main identity provider for the whole system. All third parties as well as the ASP framework 246 register with the identity provider 202. Upon receiving a request, all participants check with identity provider 202 to ensure the request is authenticated properly.

A set of tools are designed to help third parties and users to use the services of the platform easier. For example, one tool includes a third-party developers' portal where third parties deploy applications to the platform and monitor the lifecycle, performance and adoption of their application. Another example tool is the “Directory and Discovery” tool, an application that helps users find applications that best suit their needs.

The e-commerce platform 218 also includes a number of databases, such as a main database 222, and a third-party application database 236 that includes lists and basic details about applications to provide to users. It also includes a user and configuration database 238 to store user and configuration data.

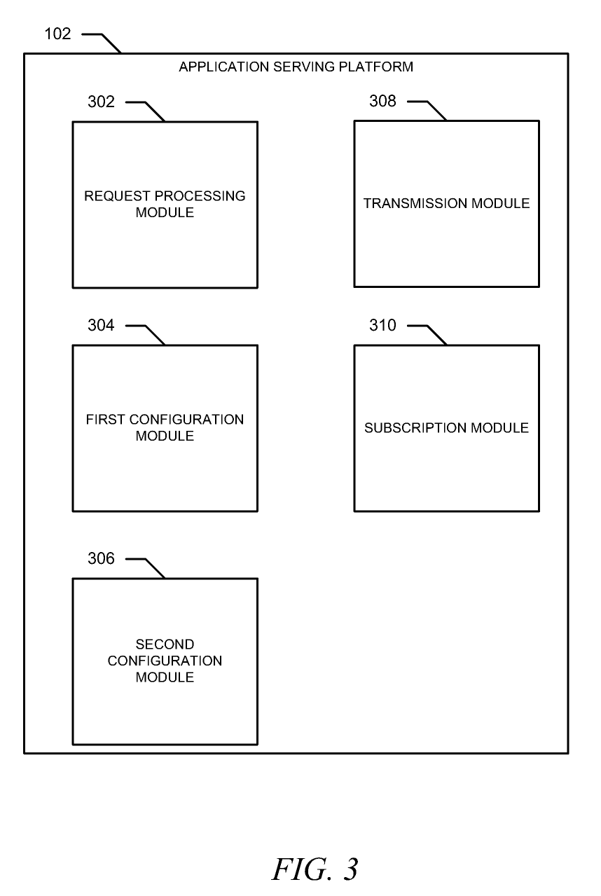

FIG. 3 is a block diagram illustrating modules of an application serving platform used in creating subscriptions, according to an example embodiment. The request processing module 302 receives, at the e-commerce platform 218, a user-initiated request to subscribe to an application. The first configuration module 304 receives configuration data associated with a first plurality of subscription configuration fields requested by the e-commerce platform 218, and the second configuration module 306 receives configuration data associated with a second plurality of subscription configuration fields requested by the third party. The transmission module 308 transmits the first configuration data and the second configuration data to the third party so as to enable the third party to authorize the user-initiated request to subscribe to the service, and the subscription module 310 creates the subscription to the service at the e-commerce platform 218.

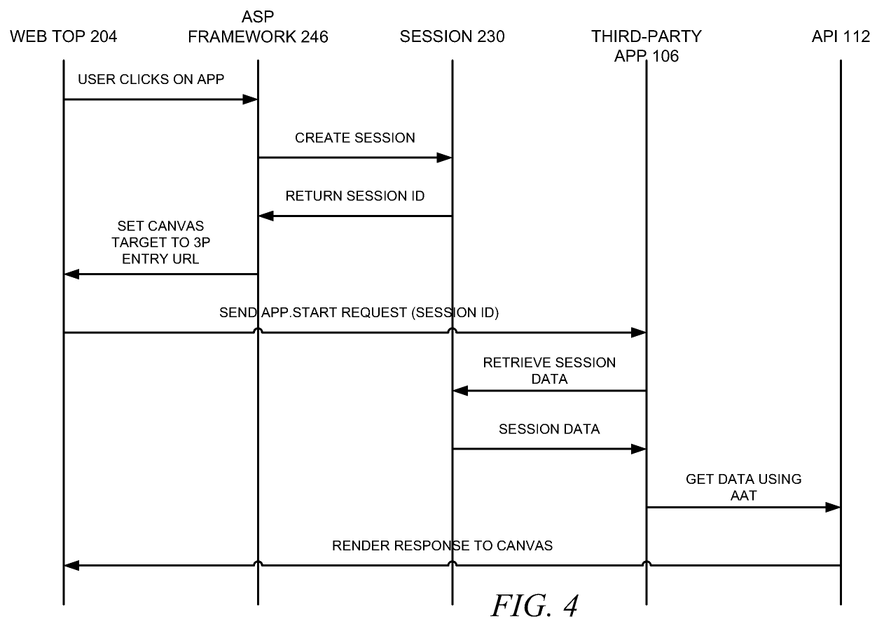

FIG. 4 is a workflow diagram illustrating a basic interaction between the application serving platform 102 and the third-party application 106, according to an example embodiment.

First, a user clicks on the third-party application reference (e.g., a link) in the Web Top 204. Next, the Web Top 204 sends a request to invoke/execute the third-party application 106 to the ASP framework 246.

The framework 246 creates a session 230 (if it already does not exist) and figures out the physical URL to the application's main entry point.

The framework 246 generates the ASP application, creates a start request and sends it to the third-party application 106 user entry point 216 together with the sessionId for the current user 116.

The third-party application 106 receives the request and uses the sessionId to retrieve the session data. The session data includes a specially created authorization and authorization token that can be used to make regular API calls. It also includes user identification information and any additional context information needed.

The third-party application makes any API calls needed to collect required data from marketplace API 112 and construct the page to be rendered. The page is constructed using normal HTML, JS, CSS, Flash etc. and does not have to use any specific markup language, in an example embodiment.

Next, the third-party application responds with the constructed page, which is rendered directly in the user's browser.

After this sequence of events, the user may view the first page of the application in the Web Top 204. The user may then proceed to interact with the third-party application 106, which now appears as integrated with the e-commerce platform 218.

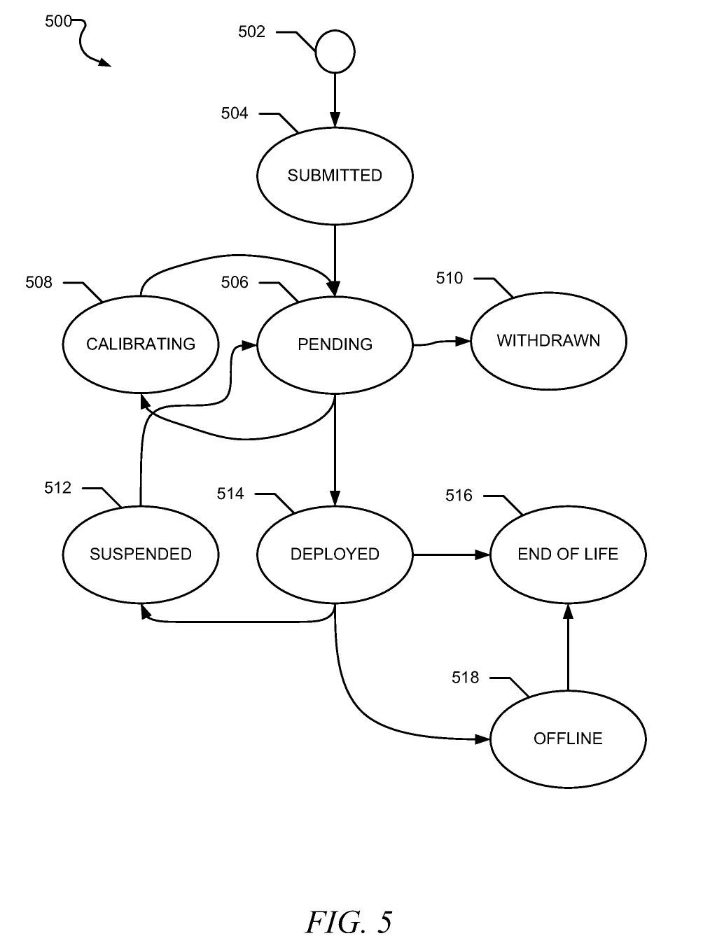

FIG. 5 is a block diagram illustrating a lifecycle 500 of a third-party application in the application serving platform, according to an example embodiment.

The lifecycle starts at entry point 502 when a third-party submits as application to be included in the ASP 102 directory. The application may be in “Submitted” state 504 by filling out a deployment form or by submitting the URL to a valid ASP 102 deployment descriptor file. Once a request is received, the application transitions to the Pending 506 state once it is assigned for review. In one example embodiment, review is handled by employees at the marketplace site.

After examination, the application either enters the Deployed state 514 or Calibrating state 508 if it needs any modifications to pass review. End-users may subscribe to application in Deployed state 514. The third-party developer of an application can choose to take a deployed application Offline 518 for scheduled maintenance and bring it back online. Third-party developers can also elect to End of Life (EOL) an application. Notice that end-user can no longer subscribe to an application in EOL state 516. Also, the existing subscribers can no longer use an EOL application.

In some circumstances, a deployed application might enter the suspended state 512. In this case, the developer contact (included in deployment descriptor) may receive a notification. Applications may not be available to subscribers while suspended. Once the reasons for suspension are addressed, the application may be reviewed and return to the Deployed state 514.

Third-party developers may monitor the state of each application along with any additional information associated with state transitions in the third-party portal 242.

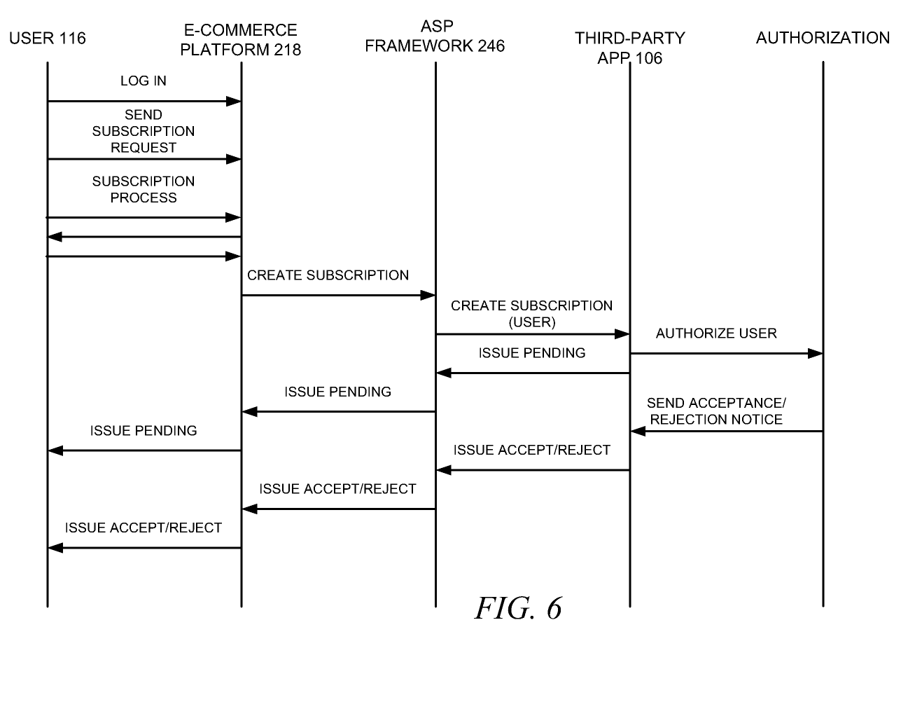

FIG. 6 is a workflow diagram illustrating an interaction between a user and the third-party application, according to an example embodiment. First, the user logs into the e-commerce platform and sends a request to subscribe to a third-party application 106 to the e-commerce platform. This begins a subscription process wherein the user provides configuration data to the e-commerce platform. After that process is complete, the e-commerce platform sends a message to the ASP framework to create the subscription. The ASP framework sends that request with the user identification details to the third-party application 106, which attempts to authorize the user. While the authorization takes place, the third-party application 106 may issue a pending alert back to the ASP framework, which sends the alert to the e-commerce platform and eventually to the user informing him or her that the subscription request is pending. After authorization, the third-party application either issues an acceptance or rejection back to the ASP framework. If the subscription request is accepted, the subscription is created.

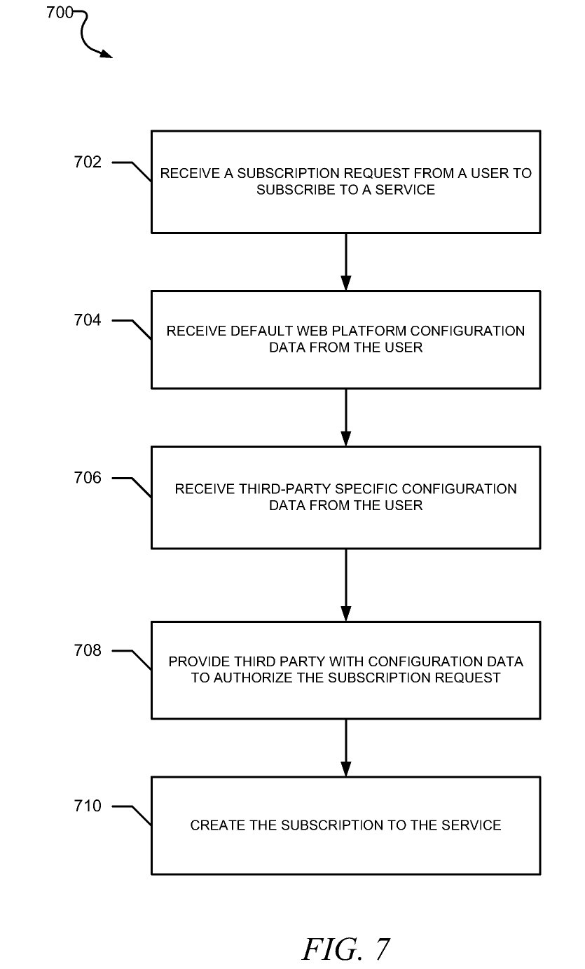

FIG. 7 is a flow chart of a method of creating a subscription to a third-party application according to various example embodiments. While operations of the method 700 are described below as being performed by specific components or modules, it will be appreciated that these operations need not necessarily be performed by the specific components identified, and could be performed by a variety of components and modules, potentially distributed over a number of machines. Alternatively, at least certain ones of the variety of components and modules described herein can be arranged within a single hardware, software, or firmware component.

At operation 702, the e-commerce platform receives a subscription request from a user to subscribe to a third-party application, also referred to as a service. At operation 704, the e-commerce platform receives, from the user, configuration data that is standard for most applications. In another embodiment, the e-commerce platform already has this information saved from a previous transaction. At operation 706, the e-commerce platform receives specific third-party configuration data from the user that is used for the application to which the user is attempting to subscribe. At operation 708, the e-commerce platform provides the third party with the configuration data, both defaults and specific, so that the third party may authorize or deny the subscription request. If the request is accepted, the e-commerce platform creates the subscription to the service at operation 710.

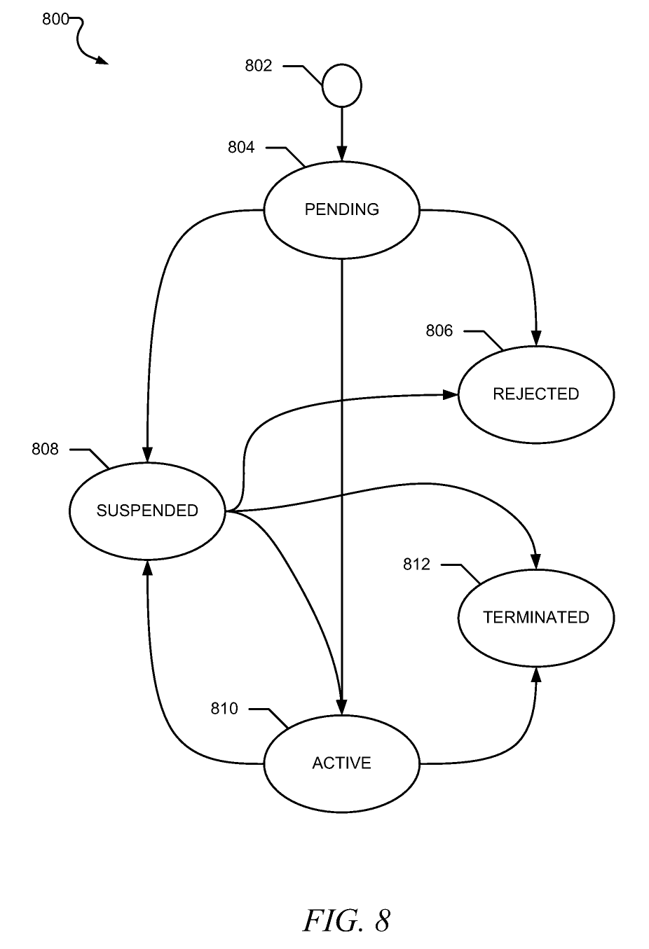

FIG. 8 is a block diagram illustrating a lifecycle 800 of a subscription request to the application serving platform, according to an example embodiment.

When a user 116 agrees to the third-party's terms and conditions and gives consent to sending the third-party his/her identification information, the ASP 102 sends a Mgmt.AddSubscriber( ) request to the application Management and Configuration service. At this point, the state of the subscription is set to “Pending” 804. The application may respond with AddSubscritponResult type (no HTML or user facing response). The final format of this type is to be finalized; however, the return has three main semantics: accepted, pending, and rejected.

The ASP framework 246, in an example embodiment, gives the third-party application 106 an opportunity to accept and review the subscription request and respond appropriately. Based on the response, the ASP 102 sets the state of the subscription to “Active” 810, “Rejected” 806, or keeps it in the “Pending” 804 state.

Subscription requests may be accepted and transition to “Active” 810 state immediately (with all the communications transparent to the user); however the architecture accounts for the possibility of a pending subscription where third-party application 106 vendors need to perform checks and verifications of their own before confirming the subscription.

If third-party application 106 returns with a “Pending” result, it has the responsibility to send a subscriber added event when it actually confirms the subscription or a rejected event if the subscription request is rejected.

A subscription might be suspended by the ASP 102 or by the third-party application 106 for any reason. In that case, the state of the subscription is transitioned to “Suspended” 808. Also, if a user 116 is suspended, all of his or her subscriptions may be suspended as well; however, a suspended subscription does not mean the user owning it is also suspended. Users 116 may also end or cancel their subscriptions. In that case, the state of a subscription is set to “Terminated” 812.

The state of one or all subscriptions to the application, along with other subscription information can be obtained by making appropriate calls to the application integration services 110 management module 232.

### Example Machine Architecture and Machine-Readable Medium

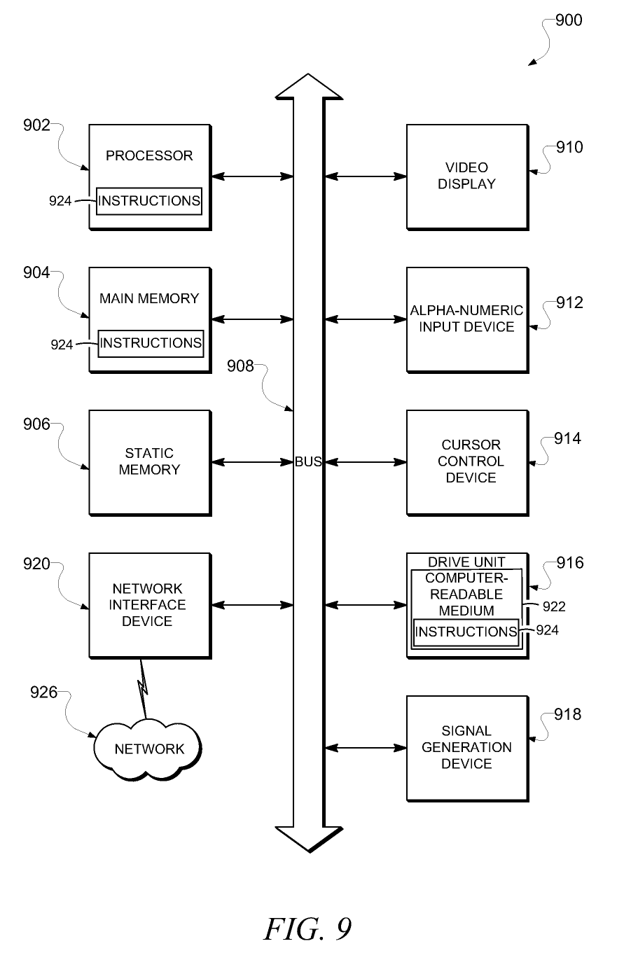

FIG. 9 is a block diagram of a machine in the example form of a computer system 900 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or client devices in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of instructions 924 and data structures (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., Hypertext Transfer Protocol (HTTP)). Examples of communication networks include a local area network (LAN), a wide area network (WAN), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible medium to facilitate communication of such software.

### Modules, Components and Logic

Certain embodiments are described herein as including logic or a number of components, modules, or mechanisms. A component is a tangible unit capable of performing certain operations and may be configured or arranged in a certain manner. In example embodiments, one or more computer systems (e.g., a standalone, client or server computer system) or one or more components of a computer system (e.g., a processor or a group of processors) may be configured by software (e.g., an application or application portion) as a component that operates to perform certain operations as described herein

In various embodiments, a component may be implemented mechanically or electronically. For example, a component may comprise dedicated circuitry or logic that is permanently configured (e.g., as a special-purpose processor) to perform certain operations. A component may also comprise programmable logic or circuitry (e.g., as encompassed within a general-purpose processor or other programmable processor) that is temporarily configured by software to perform certain operations. It will be appreciated that the decision to implement a component mechanically, in dedicated and permanently configured circuitry, or in temporarily configured circuitry (e.g., configured by software), may be driven by cost and time considerations.

Accordingly, the term “component” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which components are temporarily configured (e.g., programmed), each of the components need not be configured or instantiated at any one instance in time. For example, where the components comprise a general-purpose processor configured using software, the general-purpose processor may be configured as respective different components at different times. Software may accordingly configure a processor, for example, to constitute a particular component at one instance of time and to constitute a different component at a different instance of time.

Components can provide information to, and receive information from, other components. Accordingly, the described components may be regarded as being communicatively coupled. Where multiple of such components exist contemporaneously, communications may be achieved through signal transmission (e.g., over appropriate circuits and buses) that connect the components. In embodiments in which multiple components are configured or instantiated at different times, communications between such components may be achieved, for example, through the storage and retrieval of information in memory structures to which the multiple components have access. For example, one component may perform an operation and store the output of that operation in a memory device to which it is communicatively coupled. A further component may then, at a later time, access the memory device to retrieve and process the stored output. Components may also initiate communications with input or output devices, and can operate on a resource (e.g., a collection of information).

Although certain specific example embodiments are described herein, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments are described and illustrated in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method to authorize and create a subscription to a service, the method comprising:
receiving, at an e-commerce platform, a user-initiated request to subscribe to the service;
receiving first configuration data associated with a first plurality of subscription configuration fields requested by the e-commerce platform;
receiving second configuration data associated with a second plurality of subscription configuration fields requested by a provider of the service;
transmitting the first configuration data and the second configuration data to the provider of the service so as to enable the provider to authorize the user-initiated request to subscribe to the service; and
creating the subscription to the service using a microprocessor.

2. The method of claim 1, wherein authorizing the user-initiated request comprises:
issuing a pending alert to the e-commerce platform;
determining a plurality of user characteristics using the first configuration data and the second configuration data;
authorizing the user-initiated request if the plurality of user characteristics is accepted by the provider of the service; and
revoking the pending alert.

3. The method of claim 1, wherein the provider of the service is a third-party provider of business applications associated with the e-commerce platform.

4. The method of claim 1, wherein the first plurality of subscription configuration fields includes information common to a plurality of applications associated with the e-commerce platform.

5. The method of claim 1, wherein the second plurality of subscription configuration fields includes a subscription payment method and payment amount to be charged at a chosen interval of time.

6. The method of claim 5, wherein the provider of the service offers a free trial period for the subscription that does not require the payment amount.

7. A system to authorize and create a subscription to a service, the system comprising:
a request processing module to receive, at an e-commerce platform, a user-initiated request to subscribe to the service;
a first configuration module to receive first configuration data associated with a first plurality of subscription configuration fields requested by the e-commerce platform;
a second configuration module to receive second configuration data associated with a second plurality of subscription configuration fields requested by a provider of the service;
a transmission module to transmit the first configuration data and the second configuration data to the provider of the service so as to enable the provider to authorize the user-initiated request to subscribe to the service; and
a subscription module to create the subscription to the service using a microprocessor.

8. The system of claim 1, wherein the provider of the service is a third-party provider of business applications associated with the e-commerce platform.

9. The system of claim 7, wherein the first plurality of subscription configuration fields includes information common to a plurality of applications associated with the e-commerce platform.

10. The system of claim 7, wherein the second plurality of subscription configuration fields includes a subscription payment system and payment amount to be charged at a chosen interval of time.

11. The system of claim 10, wherein the provider of the service offers a free trial period for the subscription that does not require the payment amount.

12. A machine-readable medium with an executable program stored thereon, wherein the program instructs a microprocessor to:
receive, at an e-commerce platform, a user-initiated request to subscribe to the service;
receive first configuration data associated with a first plurality of subscription configuration fields requested by the e-commerce platform;
receive second configuration data associated with a second plurality of subscription configuration fields requested by a provider of the service;
transmit the first configuration data and the second configuration data to the provider of the service so as to enable the provider to authorize the user-initiated request to subscribe to the service; and
create the subscription to the service using a microprocessor.

13. The machine-readable medium of claim 12, wherein the provider of the service is a third-party provider of business applications associated with the e-commerce platform.

14. The machine-readable medium of claim 12, wherein the first plurality of subscription configuration fields includes information common to a plurality of applications associated with the e-commerce platform.

15. The machine-readable medium of claim 12, wherein the second plurality of subscription configuration fields includes a subscription payment machine-readable medium and payment amount to be charged at a chosen interval of time.

16. The machine-readable medium of claim 15, wherein the provider of the service offers a free trial period for the subscription that does not require the payment amount.
